(19) United States
(12) Patent Application Publication
(10) Pub. No.: US 2007/0151827 A1
(43) Pub. Date: Jul. 5, 2007

(54) Cash recycling system having a cash receiving unit and a cash dispensing unit

(76) Inventors: Michael Brandstrom, Limhamn (SE); Anders Sjostrom, Lund (SE); Jerry Karlsson, Lund (SE); Kjell Anderson, Loddekopinge (SE); Lars Malmgren, Malmo (SE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/649,953

(22) Filed: Jan. 5, 2007

Related U.S. Application Data
(63) Continuation of application No. PCT/SE05/01120, filed on Jul. 6, 2005.
(60) Provisional application No. 60/585,909, filed on Jul. 7, 2004.

(30) Foreign Application Priority Data
Jul. 6, 2005 (SE) 0401774-5

(51) Int. Cl. G07F 7/04

(52) U.S. Cl. 194/206

(57) ABSTRACT

A cash recycling system is presented which has a cash receiving unit, the cash receiving unit has a cash input module, a cash processor, a cash output module, and a cash dispensing unit. The cash dispensing unit has a cash input module, a cash processor, and a cash output module. The cash input module of the cash receiving unit and the cash output module of the cash dispensing unit are accessible to a first type of user. The cash dispensing unit and the cash receiving unit are physically separate from and operative independently of each other. The cash output module of the cash receiving unit is adapted to supply cash, as processed by the cash processor, in a form which is sorted in denomination and therefore directly suitable for loading into the cash input module of the cash dispensing unit.

### CROSS-REFRENCE TO RELATED APPLICATION

This application is a continuation of International Application No. PCT/SE2005/001120, filed Jul. 6, 2005 and designationg the United States, which claims priority to Swedish Patent Application No. 0401774-5, filed Jul. 6, 2004 and U.S. Provisional Patent Application No. 60/585,909, filed on Jul. 7, 2004.

### INCORPORATION BY REFERENCE

The specification and drawings of International Application No. PCT/SE2005/001120, filed Jul. 6, 2005, the specificaiton and drawings of Swedish patent application no. 0502492-2, filed on Nov. 11, 2005 and the specification and drawings of U.S. provisional patent application No. 60/736,601, filed on Nov. 14, 2005, are incorporated herein in their entirety, by this reference.

### FIELD OF THE INVENTION

The present invention relates to cash recycling, and more specifically to a cash recycling system which is particularly useful at commercial premises with plural stations for cash payment.

### TECHNICAL BACKGROUND

Examples of commercial premises with plural stations for cash payment include supermarkets, malls, shopping areas, casinos, race tracks, gaming establishments and stores. Particularly for large premises, having for instance 10-100 stations for cash payment in the form of checkout stations/lanes/counters, safe and efficient cash handling is of great importance.

FIGS. 1 and 2 schematically illustrate the typical cash flow in a supermarket 100. A cashier area 110 has a plurality of checkout stations 112a-n, each operated by a human cashier. At certain times, for instance at the start and end of the working shift, a cashier 111 will transport cash, as indicated by an arrow 102, in the form of notes and coins to and from the cashier area 110 and a central cash room 122 at a back-office cash handling area 120. The cash room 122 is illustrated in more detail in FIG. 2. Here, various transactions take place, such as counting/sorting and depositing of the cash takings or collecting exchange notes and coins in suitable volumes. The actual counting/sorting of the cash takings may be made manually by the cashier 111, or by way of a coin counting/sorting machine and a note validating machine which are not shown in the drawing and which are operated by a back-office operator 121. When it comes to cash recycling, the cashier 111 (or back-office operator 121) will typically use a coin recycling machine 124 which produces coin rolls made of e.g. paper from received coins (arrow 127a). The coins that are loaded into the coin recycling machine 124 must either be sorted in advance, or otherwise must the coin recycling machine 124 itself have sorting capabilities. Correspondingly, a note recycling machine 125 produces bundles of notes supplied by cashier 111 or back-office operator 121 (arrow 127b). Alternatively, cash may be recycled externally (arrow 104) by way of a Cash In Transit (CIT) company 140.

Excess cash is deposited in a safety vault 126, as indicated by arrows 127c-d, to which normally only CIT personnel 141 has access.

The supermarket 100 often also has a customer self-service area 130 with facilities such as a vending machine 132, a CDS machine 134 and an ATM machine 136. The CDS (“cash deposit system”) machine 134 is used for depositing cash in the form of coins and/or notes. The deposited amount may be credited to e.g. a bank account of a customer 131, or a voucher or credit receipt may be issued by means of which the customer may collect a corresponding value in cash (typically notes and/or high-value coins) or buy articles in the supermarket 100. The ATM (“automatic teller machine”) 136 allows the customer 131 to automatically withdraw cash from a bank account and receive notes for the amount withdrawn. There is a cash flow 106 also between the customer self-service area 130 and the cash room 122. For this reason, the customer self-service area 130 is often located close to or in combination with the cash room 122.

The prior art cash room 122 of FIG. 2 has a number of shortcomings. Safety is one; the cashier 111 is admitted into the cash room 111 through a door 124 in the surrounding wall 126. Even if access to this door is restricted by way of a key, magnetic card, personal code, etc, there are evident safety risks both as regards the honesty of the cashier 111 himself and the risk that a foreign person may force the cashier 111 to open the cash room 122.

Another disadvantage is that the approach is labor-intensive, involving many manual transactions 127a-e for both cashier 111 and back-office operator 121.

An alternative prior art approach is illustrated in FIG. 3. Here, the cashier 111 is not admitted into the cash room 122. Instead, he will use an automatic merchant teller machine 123 for all cash transactions with the cash room. From the cashier's view, the automatic merchant teller machine 123 is a sophisticated, single, all-functions-included apparatus that has functions for coin deposit, note deposit, dispensing of coin rolls or loose coins, and dispensing of notes. However, extensive manual labor is still required by the back-office operator 121 for moving received loose coins (127a) to the coin recycling, roll-making machine 124; loading coin rolls into the automatic merchant teller machine 123; moving received loose notes (127b) to the note recycling, bundle-making machine 125; and loading bundles of notes into the automatic merchant teller machine 123. Another drawback with this alternative is that the automatic merchant teller machine 123 will often be a bottle-neck in the cash handling; imagine for instance 10 cashiers starting or ending their work shift at the same time and all needing to use the automatic merchant teller machine 123. Moreover, a malfunction in a single function (for instance a coin jam in the coin receiving section) will effectively stop all cash handling, since the machine 123 cannot be used until service personnel has remedied the malfunction.

Attempts have been made in the technical field to perform cash recycling by means of a single cash recycling apparatus, like the automatic merchant teller machine 123 of FIG. 3 but with internal recycling of coins and notes, so that one user at the time may use the single cash re-cycling apparatus for deposit transactions or dispensing transactions as desired. However, a problem experienced with such a single cash recycling apparatus in practical applications is that there will often be a mismatch in denomination distribution between cash deposited by users and cash that users want to collect. For instance, large-value coins such as 1 and 2 EUR coins may be frequent among the deposited cash (e.g. because many customers pay with such denominations), whereas small-value coins like 1, 2, 5, 10, 20 or 50 cent coins are the most desired ones for the users to collect in dispensing transactions (since such denominations are heavily used as exchange coins at the cashiers' checkout stations). Thus, in effect, a shortage of small-value coins and an abundance of large-value coins will quickly develop in a single cash recycling apparatus, therefore requiring intervention by CIT company or back-office operator for relieving the cash recycling apparatus of excessive large-value coins and replenishing small-value coins as needed. In addition, a single cash recycling apparatus will still suffer from the bottle-neck problem described above.

### SUMMARY OF THE INVENTION

An object of the invention is to solve or at least mitigate the problems associated with the prior art as described above. In particular, the invention seeks to provide a cash recycling system which operates safely and efficiently, with high operational reliability and throughput, and with reduced manual labor.

These objects are wholly or partially achieved by a cash handling system according to the appended independent claim. Preferred embodiments, and the objects, features and advantages thereof, are set forth in the dependent claims and in the following description and attached drawings.

Hence, according to one aspect of the invention, there is provided a cash recycling system having a cash receiving unit, the cash receiving unit including a cash input module, a cash processor and a cash output module, and having a cash dispensing unit, the cash dispensing unit including a cash input module, a cash processor and a cash output module. The cash input module of the cash receiving unit and the cash output module of the cash dispensing unit are accessible to a first type of user, such as cashiers at a supermarket, mall, shopping area, store, casino, race track, gaming establishment or another kind of commercial premises with plural stations for cash payment. The cash output module of the cash receiving unit is adapted to supply cash, as processed by the cash processor, in a form which is sorted in denomination and therefore is directly suitable for loading into the cash input module of the cash dispensing unit. “Directly suitable for loading” means that no intermediate step of counting or sorting the cash is required after output from the cash receiving unit and before input to the cash dispensing unit. This approach eliminates the need for separate cash counting/sorting machines and cash recycling machines for producing, e.g., coin rolls or note bundles, as in the prior art, and thus reduces the manual labor required from a back-office operator, saves back-office space and avoids investment costs for extra equipment. Preferably, the cash includes notes and coins, and optionally cheques and/or coupons. Not all such types of cash handled by the cash recycling system have to be recycled, i.e. received by the cash receiving unit and supplied for input to the cash dispensing unit. For instance, when the cash includes coins and notes as well as cheques and/or coupons, only coins and notes will typically be recycled within the meaning of the present invention; cheques and/or coupons are normally one-way means of payment.

The cash dispensing unit and the cash receiving unit are operative independently of and are physically separate from each other. Thanks to this, by dividing the cash recycling system into two separate units, one cashier may use the cash receiving unit simultaneously with another cashier using the cash dispensing unit, thereby mitigating the bottle-neck problem in the prior art and improving cash handling performance and throughput. In addition, service and maintenance will be facilitated, since the moments for such actions may be selected with regard to the current expected workload of each of the cash receiving unit and the cash dispensing unit. For instance, at dates or times when the cash receiving unit is expected to be more occupied, such as at the end of work shifts, service and maintenance may be made to the cash dispensing unit, and vice versa. The present invention also makes it easier to deal with the problem of mismatch in denomination distribution between incoming and outgoing cash, as has been experienced with single cash recycling apparatuses in the past.

In one embodiment, the cash processor of the cash receiving unit includes a note processing device and a coin processing device, wherein the note processing device and the coin processing device are operative independently of each other and are adapted for parallel processing of notes and coins. This further improves the cash handling performance and throughput.

For increased safety, in one embodiment, the cash output module of the cash receiving unit and the cash input module of the cash dispensing unit are inaccessible to said first type of user and located on the inside of a cash room, whereas the cash input module of the cash receiving unit and the cash output module of the cash dispensing unit are located on the outside of said cash room. By this arrangement, a second type of user, which normally has access to the cash room and which may be authorized personnel in the form of a back-office operator or a person from a CIT company, may collect cash from the cash output module of the cash receiving unit and directly load it into the cash input of the cash dispensing unit. The loading may be performed by manual intervention and/or by way of controlling a conveyor that transports cash from the cash output module of the cash receiving unit to the cash input module of the cash dispensing unit.

In one embodiment, the cash input module of the cash receiving unit is adapted to receive coins of mixed denominations, the cash processor of the cash receiving unit is adapted to sort said received coins into different denominations, and the cash output module of the cash receiving unit is adapted to supply sorted coins of each denomination. Further, in this or another embodiment, the cash input module of the cash receiving unit is adapted to receive bundles of notes, each bundle containing notes of one denomination only, the cash processor of the cash receiving unit is adapted to validate said received notes, and the cash output module of the cash receiving unit is adapted to supply said bundles of notes with each bundle still containing notes of one denomination only. Advantageously, in such an embodiment the cash input module of the cash receiving unit comprises a plurality of inputs, each adapted to receive bundles of notes in a respective denomination. The thus sorted coins and notes are directly loadable into the cash dispensing unit as described above. It is to be observed, though, that in other embodiments of the invention, the cash input module of the cash receiving unit may be adapted to receive cash in other formats than coins in mixed denominations and notes in single-denomination bundles.

In one embodiment, the cash processor of the cash dispensing unit operates to stack single-denomination coins in piles within reusable coin tubes, which are dispensed to the cashier at the cash dispensing unit's cash output module. Advantageously, the coin tubes are made of a rigid transparent plastic material particularly suitable for reuse and may be designed to properly fit in the appropriate compartments at the cashier's checkout station. In one embodiment, the cash processor of the cash dispensing unit is adapted to receive information indicating a desired number of coins of a specified denomination as entered by the cashier through a user interface. In response, the cash processor will supply, through the cash output module of the cash dispensing unit, a coin tube containing the desired number of coins for each specified denomination. This approach is both environmentally advantageous and offers a high degree of flexibility to the individual cashier.

The cash receiving unit and the cash dispensing unit may be connected to a computer network at the commercial premises where the system is installed. Furthermore or alternatively, the cash receiving unit and each of said plural stations for cash payment may be connected to such a computer network. By providing the cash receiving unit with means for receiving, from one of the stations, a first value related to a current total for cash handled at that station, means for determining a second value related to a total for cash received and processed in the cash receiving unit, and means for providing an output representative of a correspondence or difference between said first and second values, it is possible to verify whether the amount deposited by the cashier is the amount expected and to take appropriate action in response. Such action may include acknowledging to the cashier that the totals match (i.e. giving him a “green light”), or alerting either the cashier himself or another instance that there is a mismatch. For further increased security, the cash receiving unit and/or the cash dispensing unit may have a reader for a data carrier that identifies the cashier, so that the transaction to be performed can be accurately linked to the correct cashier. The reader may be a reader for magnetic cards or electronic cards (smart cards), a biometric reader such as a fingerprint sensor, etc.

In one embodiment, the cash receiving unit has a plurality of coin boxes positioned and adapted to receive and store coins of respective denominations as sorted by the cash processor of the cash receiving unit. Advantageously, an individual coin box is removable from said cash receiving unit by a second type of user, such as authorized personnel. In this embodiment, a coin box trolley supports said plurality of coin boxes arranged side by side.

Moreover, in this embodiment, the cash dispensing unit has a plurality of coin feeding cassettes adapted to be loaded with respective denominations of coins and to dispense said respective denominations of coins at the cash output module of the cash dispensing unit.

Advantageously, an individual coin box has an open upper end being dimensioned such that it will fit an open upper part of an individual coin feeding cassette to facilitate for said second type of user to directly load coins of a particular denomination from said individual coin box, after having been removed from the cash receiving unit, into said individual coin feeding cassette.

Each coin feeding cassette may have a coin storage, a coin dispenser and a coin tube holder, and vibration feeding means for driving coins in said coin storage towards said coin dispenser. The coin dispenser may have a dispensing mechanism that acts to dispense coins from the coin storage one by one at a certain angle into an open upper end of a coin tube in said coin tube holder.

The plurality of coin feeding cassettes are preferably arranged side by side in a frame which is extractable by the second type of user. Moreover, an individual coin feeding cassette is preferably also removable from the extractable frame by said second type of user for service or repair.

The coin tube holder is advantageously adapted to receive a coin tube suitable for multi-cycle use and made from a rigid transparent plastic material.

### BRIEF DESCRIPTION OF THE DRAWINGS

The invention will now be described with reference to the appended schematic drawings.

FIGS. 1-3 illustrate cash recycling according to the prior art.

FIGS. 4-5 illustrate a cash recycling system according to one exemplifying embodiment of the present invention.

FIGS. 6-10 illustrate in more detail the cash output module of a cash receiving unit and the cash input module of a cash dispensing unit in one embodiment of the present invention.

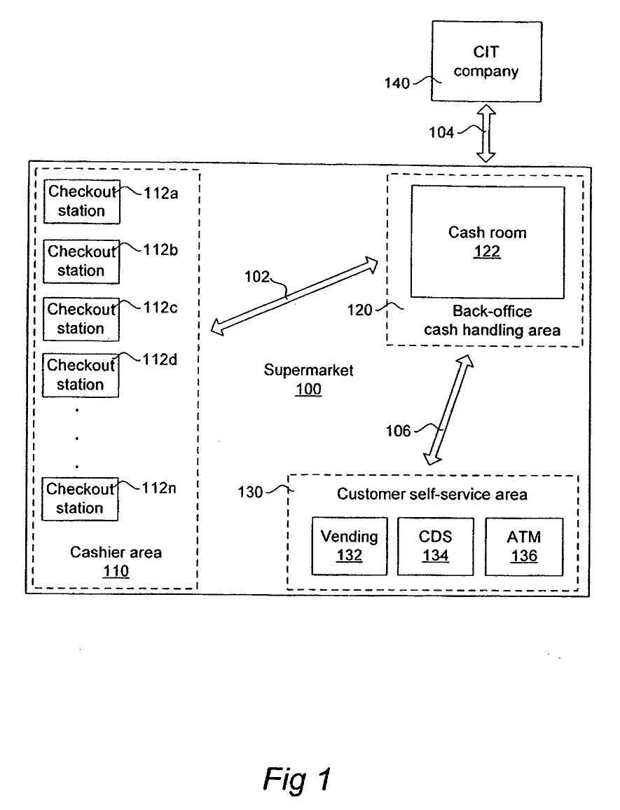

Corresponding parts are designated, where appropriate, by corresponding reference numbers throughout the drawings.

### DETAILED DESCRIPTION OF THE EXEMPLARY EMBODIMENTS

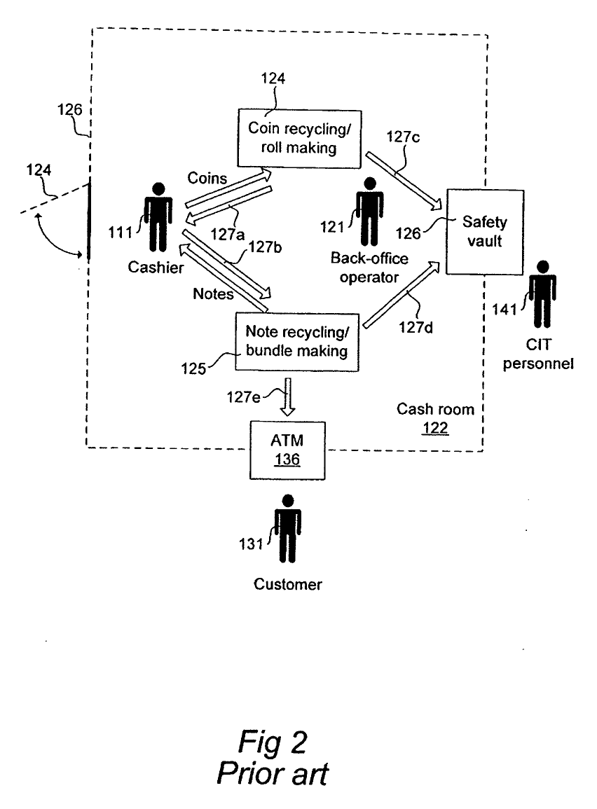

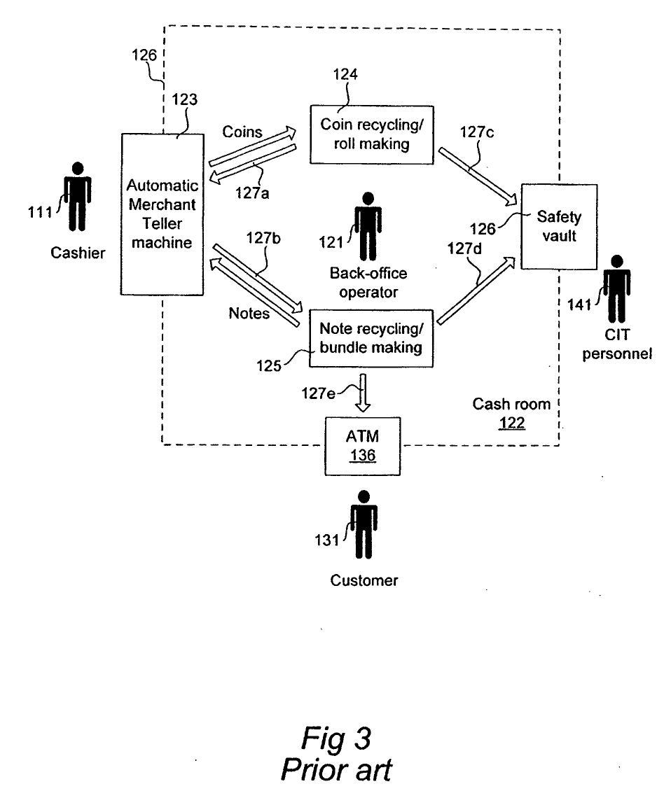

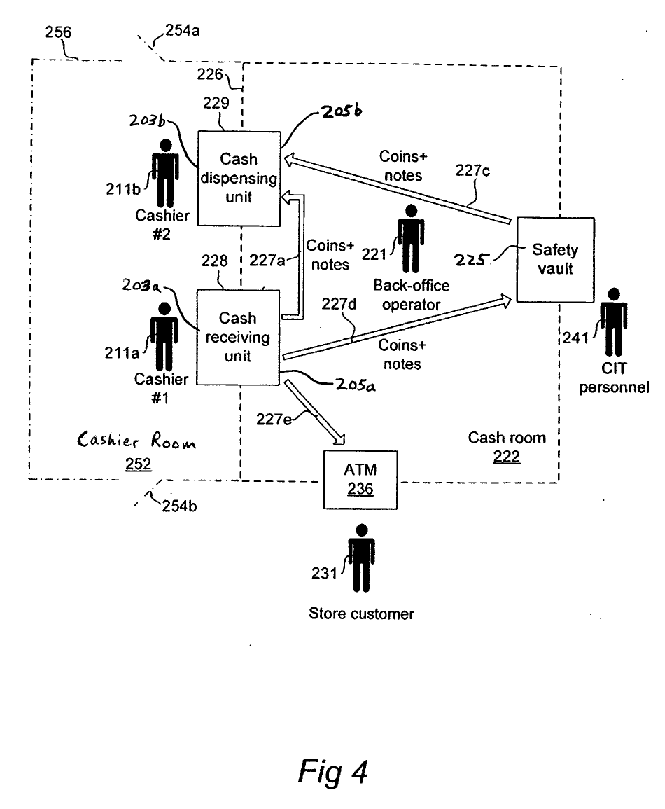

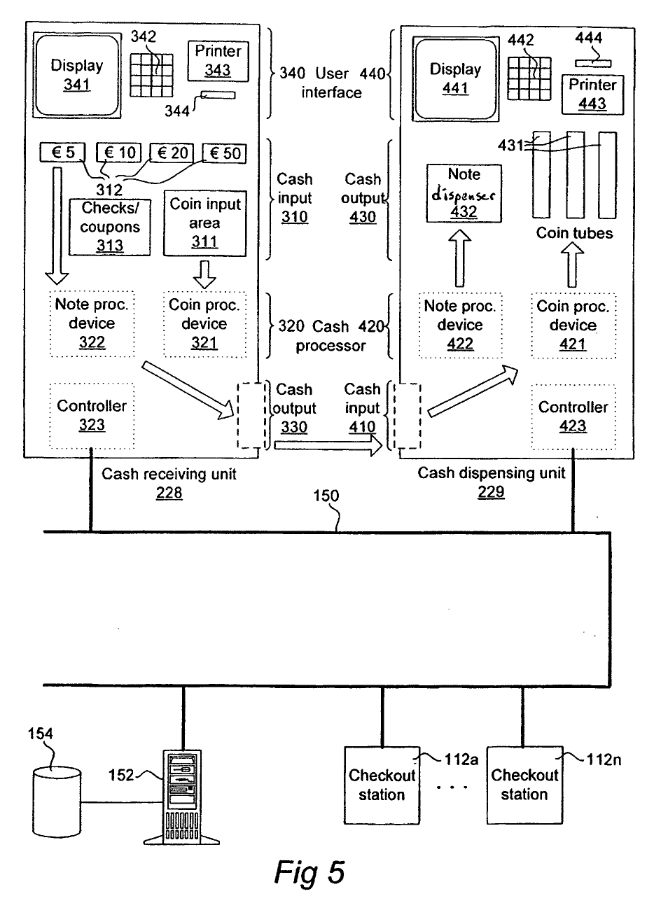

FIG. 4 illustrates a cash room 222 with a cash recycling system according to one embodiment. Elements in FIGS. 4 and 2 which are identical, similar or equivalent to each other are represented by reference numerals with the last two digits in common. As seen in FIG. 4, the cash recycling system consists of a cash receiving unit 228 and a cash dispensing unit 229. FIG. 5 illustrates these two units in more detail as schematic block diagrams. The cash receiving unit 228 and cash dispensing unit 229 are mounted in a through-the-wall manner (e.g., at least partially received in respective openings in a wall 226 that surrounds the cash room 222), so that a front side 203a, 203b (i.e., a cashier side) of each unit faces outwardly from the wall 226, and whereas a rear side 205a, 205b (i.e., a service side) of each unit is located on the inside of the cash room 222. In this manner, cashiers 211a,b will have access to the front sides 203a, 203b of units 228, 229 but not to their rear sides 205a, 205b. Only authorized personnel, such as a back-office operator 221, will have access to the rear sides 205a, 205b.

For improved security, a cashier room 252 may be formed around the front sides 203a, 203b of units 228, 229 by way of walls 256, so that the cashiers will have to pass through access-controlled doors 254a,b to access the front sides of units 228, 229. In other embodiments, the cashier room 252 may comprise less than four walls or may be an enclosure that allows less restrictive access to the cashier room. But, the cashier room 252 remains separated from the cash room 222 by wall 226 regardless of the exact configuration of the enclosure forming the cashier room. As has been explained above, the cash receiving unit 228 is adapted to supply, at its cash output module 330 which is located inside cash room 222, cash that has been processed by its cash processor into a form directly suitable for loading into the cash input module 410 of the cash dispensing unit, as indicated by an arrow 227a in FIG. 4. The loading is normally performed by the cash room operator 221, by manual labor and/or by way of a mechanical facility such as a controllable conveyor, without any intermediate counting and/or (re-)sorting of the cash. Excess cash from the cash receiving unit 228 may be deposited in a safety vault 225 (arrow 227d), and replenishment cash may be taken from this vault for supply into the cash dispensing unit 229 (arrow 227c) by the cash room operator 221 or CIT personnel 241. There may also be a cash flow 227e to an ATM machine 236 (and/or another self-service machine).

A more detailed description of the cash receiving unit 228 and cash dispensing unit 229 according to the disclosed embodiment will now be given with reference to FIG. 5. In FIG. 5, components that are available to the cashiers 211a,b (i.e., faces outwardly from the cash room wall 226) are indicated by solid lines, whereas components that are inaccessible to the cashiers 211a,b and accessible only from within the cash room 222 are indicated by dashed lines. Components that are located inside the units, and thus normally are accessible only to service personnel, are indicated by dotted lines.

The cash receiving unit 228 generally has a cash input module 310, a cash processor 320, a cash output module 330 and a user interface 340. The cash input module 310 has a plurality of note input openings 312, each of which is designed to receive a bundle of notes in a respective denomination ( [symbol] 5, [symbol] 10, [symbol] 20 and [symbol] 50) and forward it to a note processing device 322 in the cash processor 320. The note processing device 322 may be any commercially available device capable of validating and counting the notes and forward them to the cash output module 330 for later loading into the cash dispensing unit 229. The cash input module 310 also has a coin input area 311, which is designed to receive a mass of coins of mixed denominations, optionally perform some conditioning preprocessing on the coins (such as separation of dust and foreign objects) and forward them to a coin processing device 321 in the cash processor 320. There are a variety of known devices for conditioning preprocessing of coins that can be used. The coin processing device 321 may be any commercially available device capable of validating, counting and sorting the coins and forward them to the cash output module 330 for later loading into the cash dispensing unit 229. Further, the cash input module 310 has a check/coupon input area 313, which is designed to receive checks or coupons, that have been received from customers at the cashier's checkout station, and forward them to a check/coupon processing device which is not shown in the drawing.

The cash receiving unit 228 also has a controller 323 that controls the operation of the unit 228 and the various parts thereof.

The user interface 340 includes a display 341 in the form of a TFT display, a CRT display or another kind of commercially available display. A keypad 342 of any commercially available kind, such as a PIN or ITU-T type keypad and/or a set of functional keys, is provided next to the display 341. Moreover, there are provided a card reader 344 and a receipt printer 343.

In operation, the cashier 221a will approach the cash receiving unit 228 and insert his identification card in the card reader 344. After successful identification in cooperation with a server 152 (which will be described in more detail below), the cashier may select a desired transaction (i.e., coin deposit, note deposit, check/coupon deposit or combined deposits) by way of the display 341 and keypad 342. The display will guide the user by presenting informative instructions, error messages, transactions results, etc. After having deposited the cash in the cash input module 310, the cashier will wait until the processing has been completed by the cash processor 320. A verifying comparison between the amount counted by the cash processor 320 and the total amount indicated by the cashier's checkout station 112a-n may be performed. A successful transaction is acknowledged on the display 341 and/or by way of a receipt.

Reference is now made to the cash dispensing unit 229, that generally has a cash input module 410, a cash processor 420, a cash output module 430 and a user interface 440. The cash input module 410 is designed to receive cash in the form it has been delivered at the cash output module 330 of the cash receiving unit 228. Hence, the cash input module 410 will be loaded with different sets of coins, wherein the coins in each set are sorted and of a single common denomination. The loaded coins will be stored in appropriate storage means. Moreover, the cash input module 410 will be loaded with different bundles of notes, wherein the notes in each set are sorted and of a single common denomination. The loaded notes, too, will be stored in appropriate storage means.

The cash processor 420 has a note processing device 422 which is in communication with the note storage means and which is adapted to fetch a volume of notes in desired numbers, with a desired total value and/or with a desired distribution between different denominations, and supply them to the cash output module 430 to be collected by the cashier 211b. Correspondingly, a coin processing device 421 is in communication with the coin storage means and is adapted to fetch a mass of coins in desired numbers, with a desired total value and/or with a desired distribution between different denominations, and supply them to the cash output module 430 to be collected by the cashier 211b. In more detail, notes are discharged at a note dispenser 432 in the form of an externally accessible recess with a shutter—much like the cash discharge in a conventional ATM machine. Coins, on the other hand, are filled in coin tubes 431 for each denomination. Preferably, the coin tubes 431 are reusable and made of a rigid transparent plastic material. Thus, before initiating a transaction, the cashier 211b places empty coin tubes in correct positions at the cash output module 430. Only when the coin tubes have been correctly placed may the transaction commence. The coin tubes may be designed to fit in intended compartments in the checkout stations 112a-n, and/or be designed to facilitate opening of a tube and emptying of only some of the coins stored therein. Furthermore, the coin tubes may be designed to prevent coins from falling out unintentionally when the tubes are kept in a non-vertical position or upside down.

The cash dispensing unit 229 also has a controller 423 that controls the operation of the unit 229 and the various parts thereof.

The user interface 440 includes a display 441 in the form of a TFT display, a CRT display or another kind of commercially available display. A keypad 442 of any of commercially available kind, such as a PIN or ITU-T type keypad and/or a set of functional keys, is provided next to the display 441. Moreover, there are provided a card reader 444 and a receipt printer 443.

In operation, the cashier 221b will approach the cash dispensing unit 229 and insert his identification card in the card reader 444. After successful identification in cooperation with the server 152, the cashier may select a desired transaction (i.e., coin withdrawal, note withdrawal or combined withdrawals) by way of the display 441 and keypad 442. The display will guide the user by presenting informative instructions, error messages, transactions results, etc. After having placed the empty coin tubes 431, the cashier 211b will specify the details of the desired withdrawal, such as cash type (notes and/or coins), total amount, distribution between different denominations, etc, initiate the transaction and then wait until the processing has been completed by the cash processor 420. A completed transaction is acknowledged on the display 441 and/or by way of a receipt.

The direction of the cash flow between the various parts of the cash receiving unit 228 and cash dispensing unit 229 is indicated by arrows in FIG. 5.

The controllers 323 and 423 may be implemented from commercially available components, such as personal computer components like a CPU, a RAM memory, a ROM memory, a hard disk, a network card, as well as operating system software and application software. Together with the operating system, the application software will provide the various functions that are provided to a user of the units 228 and 229 through the user interfaces 340 and 440. Alternatively, the controllers 323 and 423 may be implemented by application-specific integrated circuits (ASICs), by discrete digital and/or analog components, or by any other kind of programmable arithmetic/logic components.

By way of the controllers 323 and 423, the cash receiving unit 228 and cash dispensing unit 229 are connected to a computer network 150, for instance an Ethernet and TCP/IP-based local or wide area network. Also connected to this network 150 are the checkout stations 112a-n, as well as aforesaid server 152 with an associated database 154. The server 152 may for instance support a cash/sales register application which is common to all checkout stations and to which the cash receiving unit 228 and cash dispensing unit 229 report all transactions performed by any of the cashiers. By connection to the computer network 150, the controller 323 of the cash receiving unit is capable of receiving, from one of the checkout stations 112a-n, a first value related to a current total value for cash handled at that station. The controller 323 determines a second value related to a total value for cash from the same checkout station 112a-n that has been received and processed in the cash receiving unit 228. The controller 323 provides an output representative of a correspondence or difference between the first value based on the total cash handled at a station 112a-n and the second value based on the total valve deposited in the cash receiving unit. The output verifies whether the amount deposited by the cashier is the amount expected and requests appropriate action in response. Such action may include acknowledging to the cashier that the totals match (i.e. giving him a “green light”), or alerting either the cashier himself or other personnel (e.g., cashier supervisor) that there is a mismatch. The server 152 may also support a cashier identify verification application that uses prestored identification data in the database 154 to verify the identity of an individual cashier in combination with local data which are stored on a personal data carrier for each cashier and are read by readers 344, 444 upon initialization of a new cash transaction at the cash receiving unit 228 or cash dispensing unit 229.

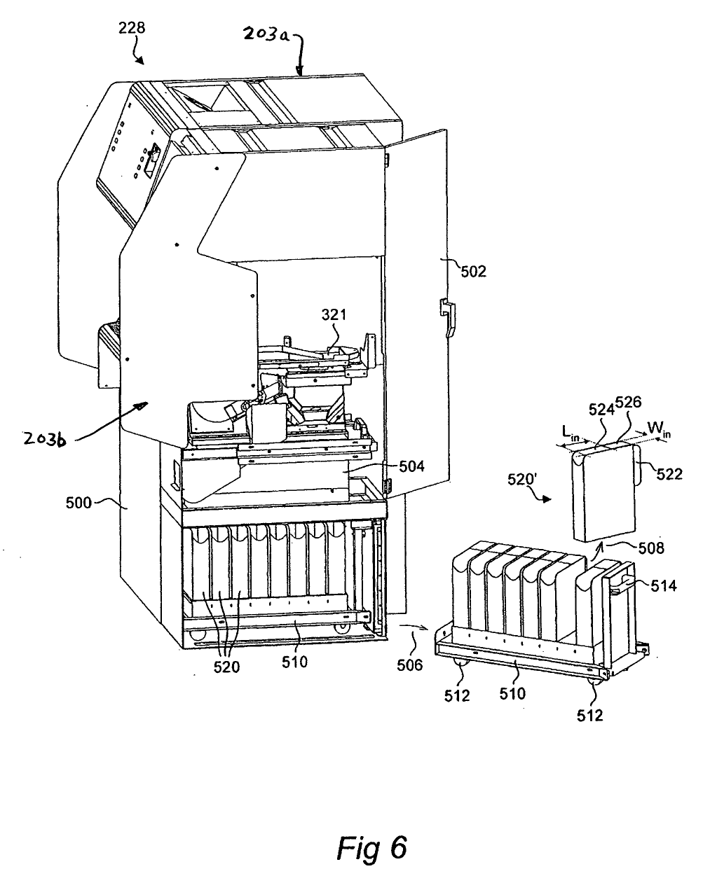

An embodiment of the cash recycling system will now be described in more detail with reference to FIGS. 6-10, particularly as regards the output of cash from the cash receiving unit 228 and the input of cash to the cash dispensing unit 229, and the way in which the cash receiving unit and cash dispensing unit interface with each other.

In FIG. 6, the cash receiving unit 228 is shown in a perspective rear view, having its casing 500 partly opened, e.g., by an unlocked and swung open casing back door 502 which normally is closed and restricts access to the interior of the cash receiving unit 228. The opened state of FIG. 6 reveals the coin processing device 321 of the aforementioned cash processor 320. The coin processing device 321 itself is referred to as a CAM (Coin Acceptance Module) and acts to receive an unsorted mass of coins and perform coin identification and sorting upon the mass of coins.

A large variety of commercially available CAM modules, or other coin processing devices, may be used as the coin processing device 321. After identification and sorting, the coins are conveyed into different channels 504, depending on the denomination of each coin.

Each of these coin channels 504 ends above a respective coin box 520 which acts to receive sorted coins of a particular denomination, as separated by the coin processing device 321. The coin boxes 520 are placed side by side on a coin box trolley 510 which has wheels 512 and a handle 514. Hence, after having opened the casing back door 502, authorized personnel may conveniently remove the coin box trolley 510 from its operating position under the coin processing device 321, as is indicated by a first arrow 506.

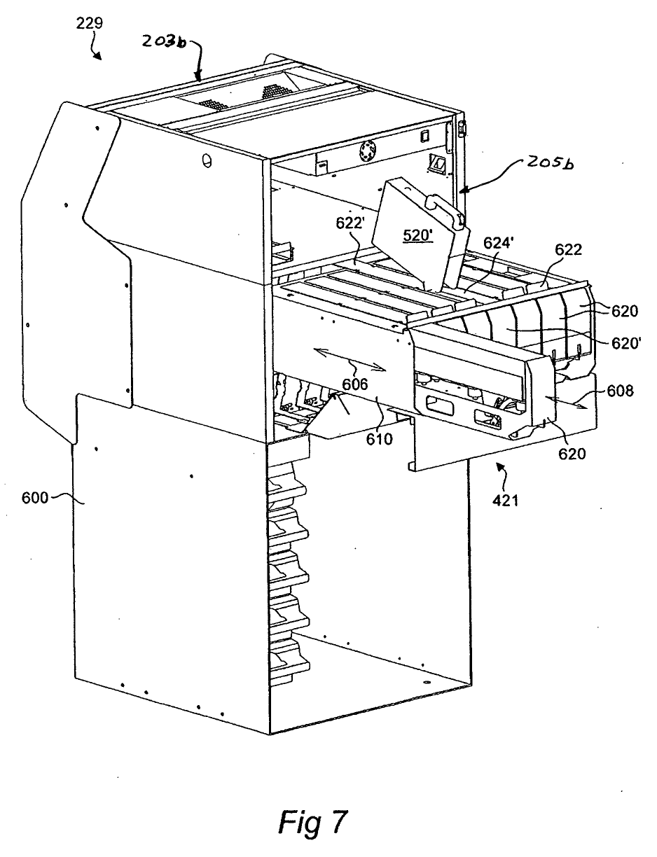

Moreover, each coin box 520 may be individually lifted off the coin box trolley 510, as is indicated by a second arrow 508 in FIG. 6. As will be explained in more detail with reference to FIG. 7, authorized personnel may thus collect such an individual coin box 520′ from the trolley 510 of the cash receiving unit 228 and directly load the cash contained therein (i.e., sorted coins of a single denomination) into a corresponding coin feeding cassette 620 (FIG. 7) in the cash dispensing unit 229 in a “pouring” fashion. To this end, each coin box 520, 520′ has an opening 524 at its upper end, said opening having a certain length Lᵢₙ and width Wᵢₙ such that the upper part of the coin box 520′ will fit snuggly in an opened upper part 624′ of the coin feeding cassette 620′, when the contents of the coin box 520′ are poured into the coin feeding cassette 620′ (see FIG. 7).

With further reference to FIG. 7, the cash dispensing unit 229 is shown in a perspective rear view, having its casing 600 partly opened, e.g. by an unlocked and swung open casing back door (not shown) which normally is closed and restricts access to the interior of the cash dispensing unit 229. The opened state of FIG. 7 reveals the coin processing device 421 of the afore-mentioned cash processor 420. The coin processing device 421 is embodied as a moveable frame 610 which accommodates a plurality of coin feeding cassettes or trays 620 arranged side by side on the moveable frame 610. During operation, the moveable frame 610 and the coin feeding cassettes 620 arranged thereon assume a retracted position wherein the cassettes are at least partially received within the casing 600. For loading of cash, and for service or repair, the frame 610 may be withdrawn from the casing 600 to the extracted position shown in FIG. 7, as is indicated by a first arrow 606.

Each coin feeding cassette 620 is adapted to store and dispense coins of a particular denomination and has an upper end 624′ which is normally shut by a slidable lid 622 but which may be uncovered by pushing the slidable lid 622 to a position 622′. In this uncovered position, and after having withdrawn the extractable frame 610, the particular coin feeding cassette 620′ on which the slidable lid 622′ is placed may be directly loaded with cash, i.e. coins of a particular denomination poured from a coin box 520′ which has been lifted by authorized personnel from the coin box trolley 510 of the cash receiving unit 228.

To facilitate service or repair, each coin feeding cassette 620 may be individually removed from the frame 610, as is indicated by a second arrow 608 in FIG. 7.

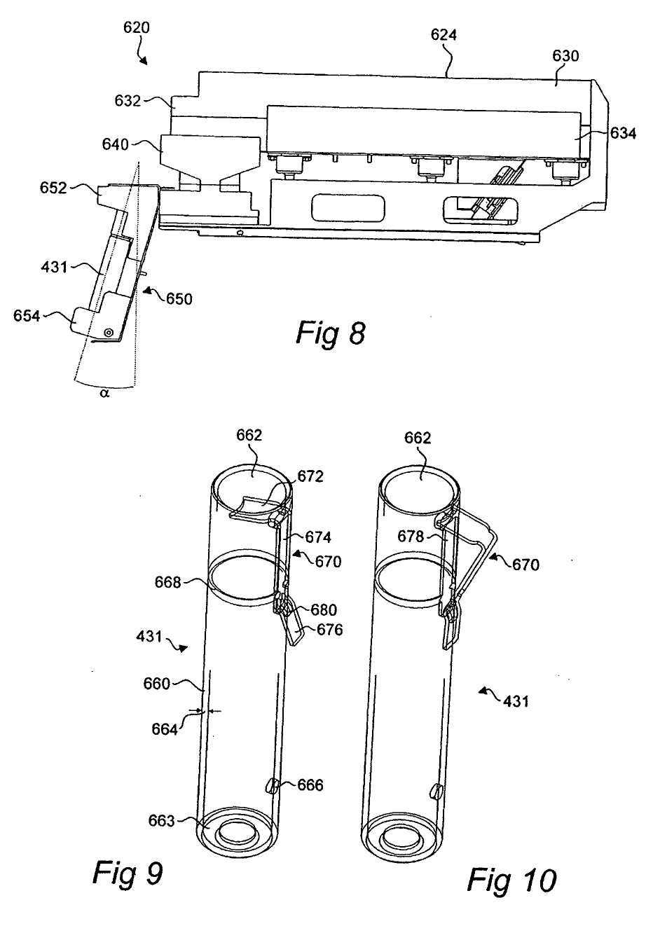

FIG. 8 illustrates a side view of an individual coin feeding cassette 620. The principal parts of the coin feeding cassette 620 are a coin storage 630, a coin dispenser 640 and a coin tube holder 650. At its upper end 624′ the coin storage 630 is covered, as already explained, by a slidable lid 622 (not shown in FIG. 8). The coin storage 630 acts as a reservoir for coins of a particular denomination and is provided with vibration feeding means 634. Thus, by causing vibrations in the bottom surface of the coin storage 630, the lowest layer of coins are driven towards one end thereof, namely the one that is indicated by 632 to the left in FIG. 8. Here, the coin dispenser 640 is provided. The coin dispenser 640 has an electromechanical dispensing mechanism that acts to dispense coins, as received from the coin storage 630, one by one at high speed and at a certain angle into an open upper end 662 (FIG. 9) of a coin tube 431. To this end, as seen in FIG. 8, the coin tube 431 rests in the coin tube holder 650 at a certain angle α to the vertical plane. Dispensing coins at an angle into an open coin tube is believed to be beneficial, since it causes the coin to rotate or spin like a discus upon contact with the interior wall of the coin tube. It is envisaged that the gyro effect of such coin rotation will assist in urging the coin down through the coin tube so as to land upon the surface of a currently uppermost coin in a stack of coins already present in the coin tube.

As is seen more clearly in FIGS. 9 and 10, each coin tube 431 has the form of a cylinder 660, with a rigid bottom 663 and having a certain wall thickness 664 which renders the coin tube reusable, i.e. suitable for multi-cycle use. As already explained, the coin tube 431 is advantageously made from a rigid transparent plastic material. The coin tube 431 has a hole 666 for engagement with fixation means in the coin tube holder 650 so as to assure safe mounting therein. The coin tube also has a locking mechanism 670 having an upper part 672 bent in an angle to a central stem 674 that ends in a bent lower part 676. The locking mechanism is fixed onto the outer surface of the coin tube's cylindrical wall 660 by an annular member 668. The locking mechanism 670 is adapted to assume a first position, shown in FIG. 9, where the upper part 672 blocks the upper end 662 of the coin tube and prevents coins from escaping or entering the coin tube. The locking mechanism 670 has means 680 that biases the parts 672-676 into the closed position in FIG. 9.

However, by actuating the lower part 676, the locking mechanism 670 may be moved to an open position shown in FIG. 10. This is the position that the locking mechanism 670 will assume when the coin tube 431 is mounted in the coin tube holder 650; when the coin tube is mounted in place, the lower part 676 will meet with a back wall of the holder, wherein the biasing will be counteracted and the upper part 672 be moved away from the open upper end 662 of the coin tube 431. Thus, the coin tube 431 may receive coins from the coin dispenser 640 in the position shown in FIG. 10.

Moreover, a user, such as a cashier 211a,b, may manually depress the angled lower part 676 and force the locking mechanism 670 into its open position before emptying the contents of the coin tube 431 into, e.g., a particular compartment of a till at a checkout station 112a-n.

In one embodiment, the locking mechanism 670 is made of metal, thereby allowing the mechanism to be used also as a means for monitoring overloading of the coin tube 431 by detecting a short circuit between a member 678 of the locking mechanism 670 and a surface of an uppermost coin in the coin tube 431. In another embodiment, the locking mechanism 670 is made of a non-metallic material, such as plastics. In such a case, monitoring for coin overloading, if desired and required, may be achieved by other means, such as a conductive element that reaches into the coin tube and into potential contact with a coin in a situation of overloading.

It is to be noted that the exact number of coin boxes 520 in the cash receiving unit 228 does not have to correspond to the number of coin feeding cassettes 620 in the cash dispensing unit 229. In FIGS. 6 and 7, a total of eight (8) coin boxes 520 are provided but only seven (7) coin feeding cassettes 620. More particularly, more than one coin box 520 may be allocated for coins of a specific denomination as received from the cash input module 310 through the coin processing device 321 and the coin channels 504, whereas more than one coin feeding cassette 620 may be allocated for coins of another specific denomination to be supplied at the cash output module 430. This allows a convenient remedy to the denomination distribution mismatch problem referred to in a previous section of this document and allows adaptation to the needs and desires of the users; frequently received denominations are allocated more than one coin box 520 in the cash receiving unit 228, and frequently desired denominations are allocated more than one coin feeding cassette 620 in the cash dispensing unit 229.

Other embodiments than the ones disclosed above are of course possible within the scope of the appended claims, as is readily realized by a person skilled in the art.

The foregoing description illustrates and describes various embodiments of the present invention. As various changes could be made in the above construction without departing from the scope of the invention, it is intended that all matter contained in the above description or shown in the accompanying drawings shall be interpreted as illustrative and not in a limiting sense. Furthermore, the scope of the invention covers various modifications, combinations, additions, and alterations, etc., of the above-described embodiments that are within the scope of the claims. Additionally, the disclosure shows and describes only selected embodiments of the invention, but the invention is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the invention without departing from the scope of the invention.

What is claimed is:

1. A cash recycling system comprising:
a cash receiving unit, the cash receiving unit including a cash input module adapted to receive coins of mixed denominations, a cash processor including a coin processing device and adapted to sort said received coins into different denominations, and a cash output module adapted to supply sorted coins of each denomination, as processed by the coin processing device; and
a cash dispensing unit, the cash dispensing unit including a cash input module adapted to be loaded with said sorted coins of each denomination, as supplied by said cash output module of the cash receiving unit, a cash processor and a cash output module,
wherein the cash input module of the cash receiving unit and the cash output module of the cash dispensing unit are accessible to a first type of user, and
wherein the cash dispensing unit and the cash receiving unit are physically separate from and operative independently of each other.

2. A cash recycling system as in claim 1, wherein the cash output module of the cash receiving unit and the cash input module of the cash dispensing unit are inaccessible to said first type of user.

3. A cash recycling system as in claim 1, wherein said cash receiving unit and said cash dispensing unit are for handling notes and coins.

4. A cash recycling system as in claim 3, wherein said cash receiving unit and said cash dispensing unit are for handling at least one of cheques and coupons.

5. A cash recycling system as in claim 1, wherein the cash processor of the cash receiving unit includes a note processing device and said coin processing device, wherein the note processing device and the coin processing device are operative independently of each other and are adapted for processing of notes and coins.

6. A cash recycling system as in claim 1, the cash processor of the cash receiving unit including a note processing device, wherein the cash input module of the cash receiving unit is adapted to receive bundles of notes, each bundle containing notes of one denomination only, the note processing device of the cash receiving unit is adapted to validate said received notes, and the cash output module of the cash receiving unit is adapted to supply said bundles of notes with each bundle still containing notes of one denomination only.

7. A cash recycling system as in claim 6, wherein the cash input module of the cash receiving unit comprises a plurality of input openings, each adapted to receive bundles of notes in a respective denomination.

8. A cash recycling system as in claim 1, wherein the cash output module of the cash dispensing unit is adapted to supply single-denomination coins in reusable coin tubes to said first type of user.

9. A cash recycling system as in claim 8, wherein the coin tubes are made of a rigid transparent plastic material.

10. A cash recycling system as in claim 8, the cash dispensing unit having a user interface, wherein the cash processor of the cash dispensing unit is adapted to receive information indicating a desired number of coins of a specified denomination through said user interface from said first type of user and to supply, through the cash output module of the cash dispensing unit, a coin tube containing the desired number of coins for each specified denomination.

11. A cash recycling system as in claim 1, wherein said first type of user includes cashiers at a supermarket, mall, shopping area, store, casino, race track or gaming establishment.

12. A cash recycling system as in claim 1, wherein the cash output module of the cash receiving unit and the cash input module of the cash dispensing unit are located on the inside of a cash room which is normally inaccessible to said first type of user, whereas the cash input module of the cash receiving unit and the cash output module of the cash dispensing unit are located on the outside of said cash room.

13. A cash recycling system as in claim 12, wherein the cash output module of the cash receiving unit and the cash input module of the cash dispensing unit are arranged to allow a second type of user, which normally has access to said cash room, to collect cash from the cash output module of the cash receiving unit and load said cash into the cash input module of the cash dispensing unit without intermediate counting or sorting of said cash.

14. A cash recycling system as in claim 13, wherein the collected cash is loaded by said second type of user by manual intervention.

15. A cash recycling system as in claim 13, wherein the collected cash is loaded by said second type of user by way of controlling a conveyor.

16. A cash recycling system as in claim 13, wherein said second type of user is a back-office operator at a supermarket, mall, shopping area, store, casino, race track or gaming establishment.

17. A cash recycling system as in claim 1, wherein the system is for installation at a commercial premises with a plurality of stations for receiving cash payments from consumers.

18. A cash recycling system as in claim 17, wherein the cash receiving unit and the cash dispensing unit are connected to a computer network at said commercial premises.

19. A cash recycling system as in claim 17, wherein the cash receiving unit and each of said plurality of stations for receiving cash payment are connected to a computer network at said commercial premises.

20. A cash recycling system as in claim 19, wherein the cash receiving unit has a controller, said controller being adapted for
receiving a first value related to a current total value for cash handled at one of said plurality of stations,
for determining a second value related to a total value for cash from said one of said plurality of stations received and processed in said cash receiving unit, and
for providing an output representative of a correspondence or difference between said first and second values.

21. A cash recycling system as in claim 20, wherein at least one of the cash receiving unit and the cash dispensing unit has a reader for a data carrier that indicates an identity of said first type of user.

22. A cash recycling system as in claim 1, wherein the cash receiving unit has a plurality of coin boxes positioned and adapted to receive and store coins of respective denominations as sorted by the cash processor of the cash receiving unit.

23. A cash recycling system as in claim 22, wherein an individual coin box is removable from said cash receiving unit by a second type of user.

24. A cash recycling system as in claim 23, comprising a coin box trolley adapted to support said plurality of coin boxes arranged side by side.

25. A cash recycling system as in claim 1, wherein the cash dispensing unit has a plurality of coin feeding cassettes adapted to be loaded with respective denominations of coins and to dispense said respective denominations of coins at the cash output module of the cash dispensing unit.

26. A cash recycling system as in claim 23, wherein said individual coin box has an open upper end being dimensioned such that it will fit an open upper part of an individual coin feeding cassette for loading of coins of a particular denomination from said individual coin box, after having been removed from the cash receiving unit, into said individual coin feeding cassette without intermediate counting or sorting of said coins.

27. A cash recycling system as in claim 25, wherein each coin feeding cassette has a coin storage, a coin dispenser and a coin tube holder, and vibration feeding means for driving coins in said coin storage towards said coin dispenser.

28. A cash recycling system as in claim 27, wherein said coin dispenser has a dispensing mechanism for dispensing coins from the coin storage one by one into an open upper end of a coin tube in said coin tube holder.

29. A cash recycling system as in claim 25, wherein said cash dispensing unit has a casing and said plurality of coin feeding cassettes being mounted on a moveable frame which is extractable from said casing by a second type of user.

30. A cash recycling system as in claim 29, wherein an individual coin feeding cassette is removable from said frame by said second type of user for service or repair.

31. A cash recycling system as in claim 27, wherein said coin tube holder is adapted to receive a coin tube made from a rigid transparent plastic material.

32. A cash recycling system comprising:
a cash receiving unit and a cash dispensing unit, each having a respective cashier side that is accessible from a cashier room and a respective service side that is not accessible from the cashier room,
the cash receiving unit comprising
a cash input module accessible from said cashier side and adapted to receive coins of mixed denominations,
a cash processor accessible from said service side and comprising a coin processing device adapted to sort said received coins into different denominations, and
a cash output module accessible from said service side and adapted to supply sorted coins of each denomination, as processed by the coin processing device, the cash dispensing unit comprising
a cash input module accessible from said service side and adapted to be loaded with said sorted coins of each denomination, as supplied by said cash output module of the cash receiving unit,
a cash processor accessible from said service side, and
a cash output module accessible from said cashier side.

33. The cash recycling system of claim 32 wherein said cash dispensing unit and said cash receiving unit are physically separate from and operative independently of each other.

34. The cash recycling system of claim 32 wherein said cash receiving unit and said cash dispensing unit are mounted in respective openings in a wall at least partially defining said cashier room.

35. The cash recycling system of claim 32 wherein said cash output module of the cash receiving unit and said cash input module of the cash dispensing unit are arranged to allow loading of cash from said cash receiving unit to said cash dispensing unit without intermediate counting or sorting of said cash.
